(19) United States
(12) Patent Application Publication
(10) Pub. No.: US 2023/0010643 A1
(43) Pub. Date: Jan. 12, 2023

(54) Pressure wave generator and method for operating a pressure wave generator

(71) Applicants: Hans Rüegg, Waltenschwil (CH); Explotechnik AG, Waltenschwil (CH)

(72) Inventor: Hans Rüegg, Waltenschwil (CH)

(21) Appl. No.: 17/754,023

(22) PCT Filed: Oct. 20, 2020
(86) PCT No.: PCT/EP2020/079524

§ 371 Date: Sep. 15, 2022

(30) Foreign Application Priority Data
Oct. 23, 2019 (CH) 01347/19

(51) Int. Cl. F04B 19/04; F04B 7/02; F04B 53/08

(52) U.S. Cl. CPC F04B 19/04; F04B 7/02; F04B 53/08

(57) ABSTRACT

A method of operating a pressure wave generator (1) with a pressure chamber (2), wherein the pressure wave generator (1) comprises
a closure element (9) which, in a closed position, closes the pressure chamber (2) with respect to an outlet (15) and, in an open position, —allows a working medium to flow out of the pressure chamber (2) into the outlet (15);
an actuator by means of which the closure element (9) can be brought from the closed position into the open position and, in particular, can also be brought from the open position into the closed position;
   wherein the method comprises repeatedly performing the following steps:
filling the pressure chamber (2) with a gaseous working medium at a pressure of over one hundred bar;
moving the actuator and thereby moving the closure element (9) in an opening direction to open the pressure chamber (2) with respect to the outlet (15), and discharging the pressurized working medium from the pressure chamber (2) through the outlet (15) within a discharge time period of less than fifteen milliseconds.

The invention relates to a device and a method for generating high intensity pressure pulses. In particular, it relates to a pressure wave generator and a method of operating a pressure wave generator according to the preamble of the independent patent claims.

In pressure wave generators, as described in WO 2007/028264 and in particular in WO 2010/025574, an auxiliary and a main explosion are ignited in chambers separated from each other. The auxiliary explosion serves to release a shutter of the main explosion chamber directly or via other latch mechanisms, so that a subsequent main explosion does not act with full force on the shutter and impair or destroy it accordingly. An explosion delay takes place between the auxiliary and main explosion. Such a delay takes place, for example, by means of a delay line in which an explosion is conducted from an auxiliary to a main chamber or by means of delayed ignition in the two chambers via separate ignition devices present in the chambers.

There is a need for a simplified pressure wave generator.

It is thus a possible objective of the invention to provide a pressure wave generator which is simplified with respect to the known devices.

It is a possible further objective of the invention to provide a pressure wave generator which is more robust and/or durable compared to known devices.

At least one of these objectives is solved by a pressure wave generator and a method of operating a pressure wave generator according to the patent claims.

The method is for operating a pressure wave generator having a pressure chamber, the pressure wave generator comprising
a closure element which, in a closed position, closes the pressure chamber to an outlet and, in an open position, allows a working medium to flow out of the pressure chamber into the outlet;
an actuator by means of which the closure element can be brought from the closed position into the open position and, in particular, can also be brought from the open position into the closed position;
   wherein the method comprises repeatedly performing the following steps:
filling the pressure chamber with a gaseous working medium at a pressure of over one hundred bar;
moving the actuator and thereby moving the closure element in an opening direction to open the pressure chamber with respect to the outlet, and discharging the pressurized working medium from the pressure chamber through the outlet within a discharge time period of less than fifteen milliseconds.

Within the discharge time period, the pressure in the pressure chamber has dropped to the ambient pressure.

In embodiments, a volume of the pressure chamber is more than three liters, more particularly more than four liters, more particularly more than five liters.

In embodiments, the area at a narrowest point of the outlet is more than twenty square centimeters, more particularly more than eighty square centimeters, more particularly more than one hundred eighty square centimeters.

In the case of a circular outlet, the above values for the area at the narrowest point, relative to its diameter and rounded, correspond to the diameter being more than five centimeters, in particular more than ten centimeters, in particular more than fifteen centimeters.

In embodiments, an opening speed of the closure element is more than ten meters/second, more particularly more than twenty meters/second, more particularly at least thirty meters/second.

In embodiments, a stroke of the closure element during the opening and closing movement is between thirty and one hundred and fifty millimeters, in particular between forty and one hundred millimeters, in particular between fifty and eighty millimeters.

In embodiments, filling the pressure chamber with the working medium occurs at a pressure of more than one hundred fifty bar, in particular more than two hundred bar.

In embodiments, the discharge time duration is less than ten milliseconds, more particularly less than five milliseconds, more particularly less than three milliseconds.

In embodiments, the working medium is one of air, nitrogen, and steam, particularly superheated steam or saturated steam.

In embodiments, the method comprises the following step performed after filling and before opening the pressure chamber:
Heating of the working medium located in the pressure chamber, in particular when flowing through a circulation line connected to the pressure chamber, in particular wherein the working medium is conveyed through the circulation line by means of a circulation blower.

In embodiments, the method comprises the following step performed during filling of the pressure chamber:
Heating of the working medium supplied to the pressure chamber, in particular when flowing through a working medium filling line.

In embodiments, the working medium is heated to a temperature of 150 degrees Celsius to 250 degrees Celsius, in particular to 230 degrees Celsius, or to a temperature of 200 degrees Celsius to 450 degrees Celsius, in particular to 250 degrees Celsius. Relatively speaking, the heating can take place, for example, by a temperature difference of more than 100 degrees Celsius, in particular more than 200 degrees Celsius, in particular more than 300 degrees Celsius, and in some circumstances more than 400 degrees Celsius. The heating can be done, for example, with an electric heating element. The outflow velocity and thus a pulse of the outflowing working medium increase with the square root of the temperature.

Another effect of heating the working medium is that the working medium can be prevented from cooling down too much when it flows out of the pressure chamber. As it flows out, the working medium relaxes to ambient pressure and can thus cool to a temperature below its liquefaction temperature, depending on the circumstances and which working medium is present. As a result, the jet spreads out after discharge at no more than the speed of sound, which limits the effect of the device.

In embodiments, a heater is present, which is arranged to heat the working medium in the pressure chamber, in particular an electric heater.

In embodiments, a heater is provided which is disposed in the working medium fill line for heating the working medium.

In embodiments, the heater is a heat exchanger, in particular with heat exchanger elements, in particular with electrically heated heat exchanger elements.

In embodiments, the method is performed using a pneumatic actuator, which comprises
a first piston surface which acts against a gaseous control medium in a first volume, wherein a pressure in the first volume causes an actuator force on the first piston surface in a first direction;
a second piston surface which acts against the control medium in a second volume, wherein a pressure in the second volume causes an actuator force on the second piston surface in a second direction opposite to the first direction;
   wherein the closure element can be brought from the closed position into the open position by the pneumatic actuator and in particular can also be brought from the open position into the closed position;
   wherein the method of opening the pressure chamber comprises the steps of:
discharging at least part of the control medium from the first volume, in particular by opening an inlet/outlet port of the first volume, and thereby opening the pressure chamber;
by a faster pressure drop in the first volume than in the second volume, moving the actuator in the second direction and thereby moving the closure element in an opening direction to open the pressure chamber with respect to an outlet, and discharging the working medium from the pressure chamber through the outlet.

In embodiments, the method is performed using a pneumatic actuator, which comprises:
a first piston surface which acts against a gaseous control medium in a first volume, wherein a pressure in the first volume causes an actuator force on the first piston surface in a first direction;
a second piston surface which acts against the control medium in a second volume, wherein a pressure in the second volume causes an actuator force on the second piston surface in a second direction opposite to the first direction.

The pneumatic actuator can be used to move the closure element from the closed position to the open position and, in particular, from the open position to the closed position.

The method comprises the repeated performance of the following steps:
a) Filling the first volume with a pressurized gaseous control medium, in particular by means of a filling valve, for example a compressed air valve;
b) Compensating the pressure between the first volume and the second volume by a throttle and thereby, due to a difference in area of the first piston area and the second piston area, moving the actuator in the first direction and thereby moving a closure element in a closing direction and closing the pressure chamber;
c) Filling the pressure chamber with a gaseous working medium;
d) Discharging at least part of the control medium from the first volume, in particular by opening an inlet/outlet port of the first volume, and thereby opening the pressure chamber;
e) by a faster pressure drop in the first volume than in the second volume, moving the actuator in the second direction and thereby moving the closure element in the opening direction to open the pressure chamber with respect to an outlet, and discharging the working medium from the pressure chamber through the outlet.

Steps a), b) and c) can be performed simultaneously or overlapping in time. Step d) is typically performed after steps a), b) and c). In step d), the opening of the pressure chamber, triggered by the opening of the inlet/outlet port, passes directly into step e).

In embodiments, a time duration between the initiation of the opening movement of—the closure element, for example by actuation of a discharge solenoid valve, and the maximum opening of the closure element is in the range of 20 milliseconds to 120 milliseconds, in particular between 40 milliseconds and 60 milliseconds.

In embodiments, the time duration for opening the closure element is thereby less than ten milliseconds, in particular less than five milliseconds, in particular less than three milliseconds. It may be substantially equal to the discharge time duration.

The pressure wave generator according to a first aspect is used to perform the method described above. It comprises a pressure chamber, and
a closure element which, in a closed position, closes the pressure chamber to an outlet and, in an open position, allows the working medium to flow out of the pressure chamber into the outlet;
an actuator by means of which the closure element can be moved from the closed position to the open position and from the open position to the closed position;
wherein a volume of the pressure chamber is more than three liters, in particular more than four liters, in particular more than five liters;
wherein in particular the volume of the pressure chamber is less than fifteen liters;
wherein the area at the narrowest point of the outlet is more than twenty square centimeters, in particular more than eighty square centimeters, in particular more than one hundred eighty square centimeters;
wherein a stroke of the closure element during the opening and closing movement is between thirty and one hundred and fifty millimeters, in particular between forty and one hundred millimeters, in particular between fifty and eighty millimeters.

This allows the pressure wave generator to produce an exit jet which, after free jet expansion in the free space, generates the greatest possible maximum pressure there, or the greatest possible force. For this purpose, the mass flow generated by the pressure wave generator is made as large as possible. The mass flow is proportional to the density and exit velocity of the working medium and to the area of the exit opening. Thus, starting from a predefined filling pressure of the gaseous working medium in the pressure chamber, a combination of parameters can be determined within the limits defined above, which generates the maximum pressure of the exit jet.

In embodiments, a closure area of a closure opening that is respectively closed and opened by the closure element is at least as large as the area at the narrowest point of the outlet, in particular at least ten percent larger than the area at the narrowest point of the outlet.

This is in contrast to a usual valve, where the valve forms the narrowest point. In the narrowest cross-section, the gas flows at the speed of sound. If this point is not at the end of the outlet, supersonic flow occurs after the narrowest point. This leads to compression shocks in the outlet, which impede the performance of the device. By having the expansion of the exit jet outside the outlet, this is prevented.

In embodiments, the closure element is hollow cylindrical and arranged to close or open a closure opening corresponding to a cylindrical surface.

The hollow cylindrical design allows a reduction in the mass of the closure element. In addition, the annular surface of the piston surrounding the hollow cylindrical recess determines a recoil force with which the escaping gases drive the piston back. In embodiments, when viewed in cross-section, the area of the hollow cylindrical recess is more than twenty-five, particularly more than fifty, percent of the area of the closure element. The cylindrical closure surface allows for a large change in area of the closure surface as a function of movement of the closure.

In embodiments, a sum of areas on the closure element where the pressurized working medium exerts a force on the closure element in the closing direction is less than ten percent of the cross-sectional area of the outlet at the point where the outlet is closed by the closure element.

In embodiments, an area of the inlet/outlet opening of the first volume is between two hundred square millimeters and five hundred square millimeters, or a maximum of one thousand five hundred square millimeters. For a round cross-section of the opening, this corresponds to a diameter, rounded, of between sixteen millimeters and twenty-five millimeters, or a maximum of forty-four millimeters. This allows sufficiently rapid emptying of the first volume and, in turn, a correspondingly rapid opening movement. It results that these diameters are by and large independent of the first piston area, i.e. the area of the piston in the first volume.

In embodiments, during an opening movement of the closure element, starting from an end position in which the closure element closes the closure opening, the closure element opens the closure opening only after covering a minimum distance. This distance is different from zero. In particular, this distance is more than five millimeters or more than eight millimeters.

A pressure wave generator according to a second aspect is used to perform the method described above. It comprises a pressure chamber, and
a closure element which, in a closed position, closes the pressure chamber to an outlet and, in an open position, allows the working medium to flow out of the pressure chamber into the outlet;
an actuator by means of which the closure element can be moved from the closed position to the open position and from the open position to the closed position;
a heater, which is arranged to heat a working medium supplied to the pressure chamber or a working medium present in the pressure chamber, in particular wherein the heater is an electric heater.

A pneumatic actuator, particularly for use in a pressure wave generator, comprises:
a first piston surface which acts against a gaseous control medium in a first volume, wherein a pressure in the first volume causes an actuator force on the first piston surface in a first direction;
a second piston surface which acts against the control medium in a second volume, wherein a pressure in the second volume causes an actuator force on the second piston surface in a second direction opposite to the first direction;
a throttle between the first volume and the second volume;
an inlet/outlet port of the first volume for introducing and discharging the control medium into and out of the first volume, respectively;
wherein the first piston area is larger than the second piston area.

In embodiments, the pneumatic actuator has end position damping, in particular by closing the inlet/outlet opening. Thus, the inlet/outlet opening is closed with respect to the first volume.

In embodiments, a piston closure element is arranged to close the inlet/outlet opening. Thus, the end position damping can be realized in a simple manner by an element of the piston itself.

In a method of operating the pneumatic actuator, the following steps are performed:
Filling the first volume with a pressurized gaseous control medium, in particular by means of a filling valve, for example a compressed air valve;
Pressure compensation between the first volume and the second volume by the throttle and thereby, due to a surface difference of the first piston surface and the second piston surface, moving the actuator in the first direction;
Discharging at least part of the control medium from the first volume, in particular by opening the inlet/outlet port;
by a faster pressure drop in the first volume than in the second volume, moving the actuator in the second direction.

It is thus possible to realize a reciprocating movement of the actuator with simple means—only the filling valve and the inlet/outlet opening. This is a consequence, on the one hand, of the surface difference between the piston surfaces and, on the other hand, of the throttle between the two volumes.

The inlet/outlet opening can be made relatively large to effect the rapid pressure drop in the first volume.

In embodiments, the piston closure element is also arranged to isolate a control medium filling line with respect to the first volume. Thus, high pressure surges in the filling line can be avoided.

In embodiments, the two volumes are realized as parts of a common working chamber of a cylinder, in which a single piston is arranged, on which the two piston surfaces are formed.

This makes the sealing of the pistons against the (now common) cylinder non-critical. There may even be a gap between the piston and cylinder. This has the function of a throttle between the two volumes. Pressure compensation therefore takes place through this gap. This allows a further simplification of the design. In this embodiment, the throttle is thus formed by the gap between the cylinder and the piston. This dispenses with an otherwise customary seal for the piston.

In another embodiment, the two volumes and piston surfaces are on separate pistons in separate cylinders, and the two separate pistons are mechanically coupled and their movements are also coupled.

In embodiments, the first piston surface and a piston closure element for closing the inlet/outlet opening are formed on the same piston. This allows for a particularly simple and reliable design.

In embodiments, the pneumatic actuator comprises a cylinder discharge valve for rapidly discharging the control medium from the first volume by opening the inlet/outlet port. The cylinder discharge valve has a piston surface on which a force is generated to close the cylinder discharge valve when the control medium is applied, and a valve surface on which a force is generated in the opening direction of the cylinder discharge valve when the control medium is applied, wherein the valve surface is smaller than the piston surface. Thus, by applying the same pressure to both surfaces, the cylinder discharge valve can be brought into the closed position and held there.

In embodiments, the pneumatic actuator includes a discharge pilot valve for discharging control medium from a discharge valve volume in which the control medium acts on the piston surface. This can be used to create a momentary, temporary imbalance of pressure on the two surfaces, thereby opening the cylinder discharge valve.

In embodiments, a control medium filling line is arranged for filling both the discharge valve volume and the first volume with control medium under the same pressure. Thus, on the one hand, the same pressure can be achieved in the two volumes, and on the other hand—by the filling line acting as a throttle between the two volumes—the temporary imbalance can be realized.

The pressure in the control medium is, for example, between 50 and 140 bar, in particular between 80 bar and 100 bar.

In embodiments, a section of the control medium filling line, through which the first volume is supplied with the control medium, runs through the cylinder discharge valve, in particular a plug of the valve. For example, this section is a passage in the plug, which allows a small flow through the valve even in the closed position of the valve.

In embodiments, a portion of the control medium fill line through which the first volume is supplied with the control medium extends through a housing of the pressure wave generator.

In embodiments, a linear guide of the piston is formed by the piston enclosing a rear closure guide and being linearly movable along the rear closure guide in a direction of movement, and a hollow cylindrical piston connecting element extending away from the piston in the direction of movement enclosing a bearing element fixed to the rear closure guide. Here, the second volume is formed between the piston, an inner surface of the piston connecting element, the bearing element, and the rear closure guide. Typically, the rear closure guide is fixedly connected to the housing.

Thus, as an extension of the hollow-cylindrical piston connecting element, a hollow-cylindrical element can be driven, which is advantageous in certain applications. For example, this is the case with the pressure wave generator described here with a hollow cylindrical closure element.

Further preferred embodiments are shown in the dependent patent claims. Features of the method claims can be combined mutatis mutandis with the device claims and vice versa.

In particular, the pressure wave generator can have a controller which is configured to control the pressure wave generator in order to carry out the method according to at least one of the method claims. The control is performed by controlling at least the valves of the pressure wave generator.

In the following, the subject matter of the invention is explained in more detail on the basis of preferred embodiment examples, which are shown in the accompanying drawings. They show schematically:

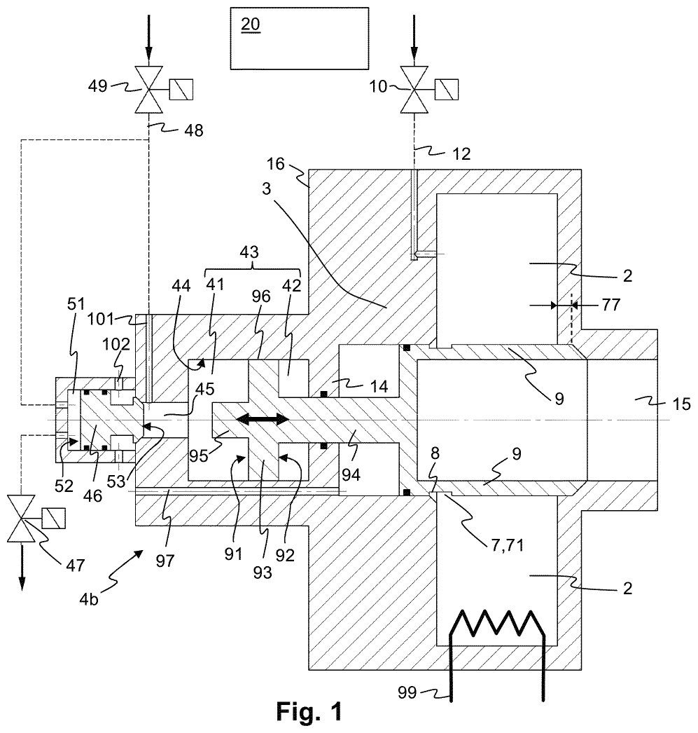

FIG. 1 a longitudinal section through a pressure wave generator;

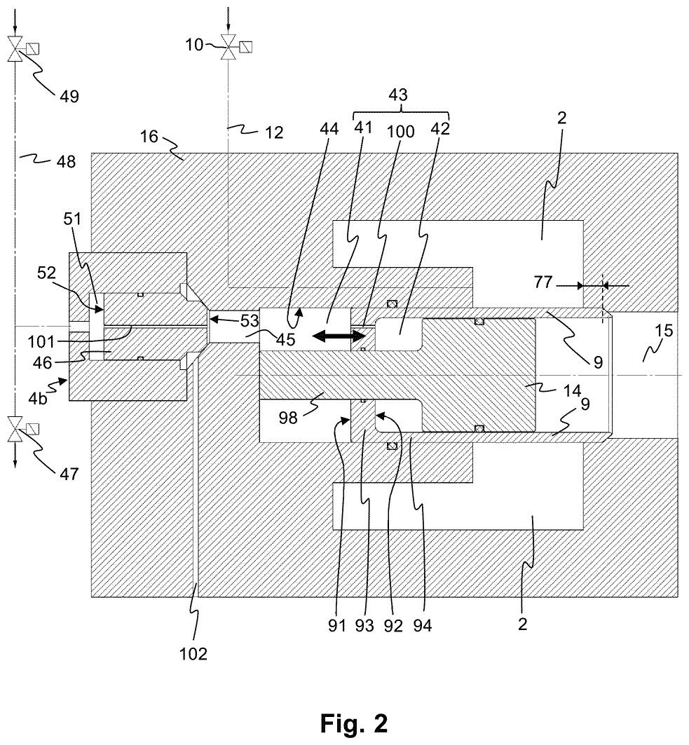

FIG. 2 a longitudinal section through another embodiment; and

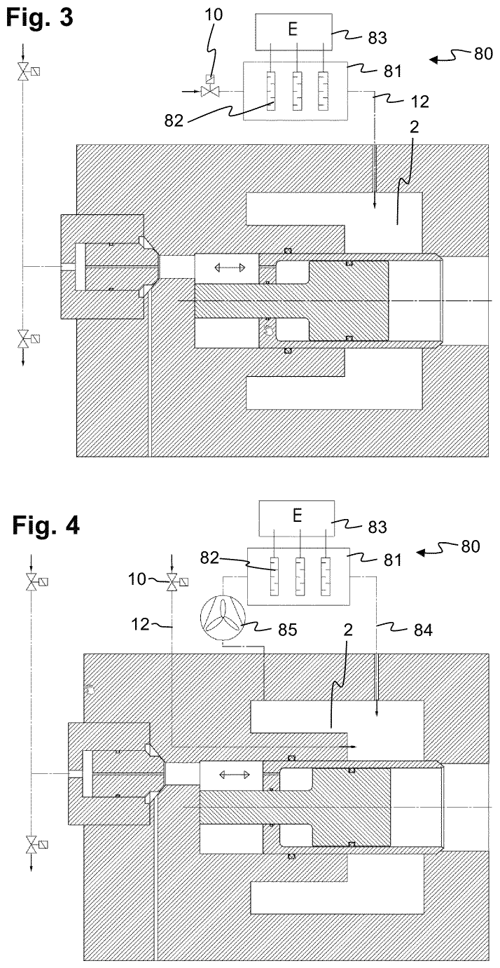

FIGS. 3-4 embodiments with a heater for heating the working medium.

In principle, same parts are given same reference signs in the figures.

FIGS. 1 and 2 each show a pressure wave generator 1 with a pressure chamber 2. A closure element 9 is arranged to close the pressure chamber 2 opposite an outlet 15.

The closure element 9 is guided on a bearing element 14, which allows a linear opening and closing movement of the closure element 9. In the embodiment of FIG. 1, the closure element 9 is hollow cylindrical and has a piston that is guided by the bearing element 14, which is fixedly connected to a housing 16. In the embodiment of FIG. 2, the closure element 9 is hollow cylindrical and surrounds the bearing element 14, which is fixedly connected to a housing 16. The direction of movement, shown by a double arrow, is typically equal to a longitudinal direction of the pressure wave generator 1, and also equal to an outflow direction in which the working medium flows out of the outlet 15. FIGS. 1 and 2 show the closure to element 9 in a closed position, i.e. the pressure chamber 2 is closed to the outlet 15.

The outlet 15 is used for the directional discharge or dischargeage of the working medium. A pressure wave can thus be generated.

In an open position, the closure element 9 releases a closure surface of a closure opening. In the closed position, the closure opening is closed by the closure element 9. Here, the closure surface is that of a cylinder. The pressure chamber 2 is annular. The pressure chamber 2 encloses the closure element 9. Starting from the pressure chamber 2, the closure opening leads inward in the radial direction—with respect to the annular pressure chamber 2. Working medium exiting through the closure opening flows inward in the radial direction and then in the axial direction—again with respect to the annular pressure chamber 2—through the outlet 15.

In the closed state, the closure element 9 is in contact with a valve seat of the housing 16. The valve seat can be designed with a collar, which means that when the closure element is moved in the opening direction, starting from an end position in the closed position, the closure opening is only opened and the working medium can flow out after the closure element 9 has covered a certain distance. This path is shown as collar width 77. This makes it possible to accelerate the movement of the closure element 9 before the closure opening is opened, which in turn makes it possible to open the closure opening sufficiently quickly to allow the working medium to flow out abruptly.

The size of the closure area is larger than the area of the outlet or outlet area, i.e. the cross-sectional area at which the outlet merges into the free space. In particular, the outlet 15 corresponds to the narrowest point along the path of the working medium out of the pressure chamber 2. As a result, the velocity of the outflowing working medium is highest at the outlet 15 or shortly thereafter. In particular, this causes the outflowing working medium to reach sonic velocity only shortly after the narrowest point, i.e. after outlet 15. This is advantageous for the operation of the device.

A first filling line or working medium filling line 12 is arranged for filling the pressure chamber 2 with a working medium. It is fed by a working medium valve 10.

In a method of operating the apparatus
the pressure chamber 2 is closed by the closing element 9 with respect to the outlet 15;
the pressure chamber 2 is filled with the working medium under high pressure, i.e. with a pressure of more than one hundred bar, in particular more than one hundred and fifty bar, in particular more than two hundred bar;
the pressure chamber 2 is opened abruptly so that the energy stored in the working medium is converted into kinetic energy over as short a period as possible. The shorter the period, the higher the velocity and momentum of the outflowing working medium and thus the effect of the pressure wave.

In embodiments, the following parameters are implemented:
Pressure: 100 bar to 300 bar
Volume: 3 liters to 15 liters
Outlet area: 50 cm² to 320 cm² (=diam. approx. 80-200 mm)
Opening speed: 15 m/s to 40 m/s
Stroke: 50 mm to 100 mm

In embodiments, the following parameters are implemented:
Pressure: more than 120 bar
Volume: 4 liters
Outlet area: 80 cm² (corresponds to a diameter of approx. 100 mm)
Opening speed: more than 15 m/s
Stroke: 60 mm

In embodiments, the following parameters are implemented:
Pressure: 250 bar to 300 bar, in particular 280 bar
Volume: 8 liters to 12 liters, in particular 10 liters
Outlet area: 150 cm² to 210 cm², in particular 180 cm² (corresponds to a diameter of about 150 mm).
Opening speed: more than 25 m/s
Stroke: 60 mm to 90 mm, in particular 75 mm

In embodiments, the following parameters are implemented:
Pressure: 250 bar to 300 bar, in particular 280 bar
Volume: 4 liters to 6 liters, in particular 5 liters
Outlet area 60 cm² to 80 cm², in particular 70 cm² (corresponds to a diameter of approx. 95 mm)
Opening speed: more than 20 m/s
Stroke: 50 mm to 70 mm, in particular 60 mm

In all embodiments, heating of the working medium to a temperature of 150 degrees Celsius to 250 degrees Celsius, in particular to 230 degrees Celsius, or to a temperature of 200 degrees Celsius to 450 degrees Celsius, in particular to 250 degrees Celsius, may be realized.

The opening movement of the closure element 9 is effected by an active gas spring or pneumatic actuator 4b. This has a cylindrical working chamber 43 with a piston 93 moving therein, the movement of which is coupled to the movement of the closure element 9, in particular by being firmly connected to one another, in particular by being formed in one piece. In the embodiments of FIGS. 1 and 2, the coupling is effected by a piston connecting element 94. In FIG. 1 this is a piston rod, in FIG. 2 this is a hollow cylinder.

The piston 93 divides the working chamber 43 into a first volume 41 and a second volume 42. There is no seal between an inner cylinder wall 44 of the working chamber 43 and the piston 93. In particular, there may also be a small gap, hereinafter referred to as piston gap 96. This allows gas exchange between the two volumes and in particular acts as a throttle. In other embodiments, a separate conduit may be arranged between the first volume 41 and the second volume 42, and have a throttle which permits gas exchange in addition to or as an alternative to the piston gap 96. Such a throttle may also be implemented as a piston throttle 100 through one or more holes through the piston 93, which thus also allows gas exchange between the two volumes.

A gas pressure of the control medium in the first volume 41 causes a force against the direction of the opening movement of the closure element 9, whereby a surface effective in this case is a first piston surface 91.

A gas pressure of the control medium in the second volume 42 causes a force in the direction of the opening movement of the closure element 9, a surface effective in this case being a second piston surface 92.

Here, the second piston area 92 is smaller than the first piston area 91, for instance at least five or ten or twenty percent smaller.

The piston 93 has a piston closure element 95, which closes a cylinder inlet/outlet 45 or inlet/outlet opening of the first volume 41 in the course of the opening movement. The cylinder inlet/outlet 45 is drawn here concentric with the working chamber 43, but could alternatively be arranged laterally. By closing the cylinder inlet/outlet 45, a braking or end position damping of the opening movement is effected. At the same time, the compressed air valve 49 is also protected from a pressure surge through the compressed air filling line 48.

The cylinder inlet/outlet 45 can be opened by a cylinder discharge valve 46. The control medium flows out, for example, through a discharge or vent line 102. The cylinder discharge valve 46 may have a relatively large valve cross-section compared to a fill line. Thus, an abrupt pressure reduction in the first volume 41 can be realized. The cylinder discharge valve 46 is held closed by a pressure in a compressed air fill line 48. This pressure can be reduced by opening a discharge pilot valve 47. Thus, opening the bleed pilot valve initiates the opening movement of the closure element.

The cylinder discharge valve 46 is exemplarily a poppet valve with a movable plug. The plug has a piston surface 52 at which it is acted upon by the compressed air from the compressed air filling line 48 in a discharge valve volume 51. A valve surface 53, which is acted upon by the pressure in the cylinder inlet/outlet 45, is smaller than the piston surface 52, and the forces on the piston surface 52 and the valve surface 53 are opposite to each other. When the discharge pilot valve 47 is closed, the gas pressure on the two surfaces is the same, and the force on the piston surface 52 is higher than that on the valve surface 53, which keeps the plug or cylinder discharge valve 46 in the closed position.

The compressed air fill line 48 also feeds, via a portion 101 of the compressed air fill line 48, the first volume 41. The compressed air fill line 48 is in turn fed via a compressed air valve 49.

A ventilation line 97 provides pressure equalization between the ambient air and an intermediate cylinder. The intermediate cylinder is located between a rear end of the closure element 9 and the active gas spring or pneumatic actuator 4b.

In the variant of the embodiment of FIG. 1, the working chamber 43 and the piston 93 are realized compactly. However, the same mode of operation can also be realized with separate first and second volumes and with separate pistons with different piston areas. In this case, a line with a throttle is arranged between the two volumes and the movements of the two pistons are mechanically coupled. This means that a linear movement of one of the two pistons always causes a linear movement of the other piston.

In the embodiments of FIG. 1 and FIG. 2, a piston travel can be, for example, between 20 mm and 150 mm, in particular between 30 mm and 80 mm. A diameter of the piston can be, for example, between 20 mm and 200 mm, in particular between 40 mm and 120 mm.

In embodiments, a heating element 99 is provided. This can be used to heat the pressurized working medium in the pressure chamber 2. This can increase the energy of the generated pressure wave.

FIGS. 1 and 2 show the pneumatic actuator 4b in combination with a pressure wave generator 1.

In the operation of this variant, the following method steps can be performed:
Opening of the compressed air valve 49 with the discharge pilot valve 47 closed. This has the following effects: The pressure in the compressed air filling line 48 (e.g. 70 bar) closes the cylinder discharge valve 46. The first volume 41 is pressurized with compressed air through the compressed air filling line 48. The second volume 42 is also pressurized through the piston gap 96, with the same pressure being present in both volumes over time. Because the first piston area 91 is larger than the second piston area 92, the piston 93 and thus the closure element 9 are moved into a closed position (against the direction of the opening movement).
Closing the compressed air valve 49. The closing element 9 remains in the closed position.
Opening the working medium valve 10 and thereby filling the pressure chamber 2.
Triggering the opening movement by opening the cylinder discharge valve 46, which can be done in particular by opening the discharge pilot valve 47 and reducing the pressure in the compressed air filling line 48. Opening the cylinder discharge valve 46 causes the pressure in the first volume 41 to drop. The pressure in the second volume 42 also drops, but more slowly than in the first volume 41 because of the throttling effect of the piston gap 96. This, in turn, causes the force on the second piston surface 92 to be greater than the force on the first piston surface 91. This causes the piston 93 to move and thus the closing element 9 to open.
Before the piston 93 or the closure element 9 reach a stop, the piston closure element 95 closes the cylinder inlet/outlet 45. The air remaining in the (now smaller) first volume 41 is compressed and slows down the movement of the piston 93 and the closure element 9. The compressed air valve 49 is prevented from being stressed by a pressure peak.
The working medium flows out of the opening which has been released by the closing element 9.
Closing the cylinder discharge valve 46, in particular by closing the discharge pilot valve 47. This can be done in that a piston area over which the compressed air in the compressed air filling line 48 presses the cylinder discharge valve 46 or its plug into the closed position is larger than an area at which the compressed air acts in the opposite direction on the cylinder discharge valve 46 or its plug. After closing the cylinder discharge valve 46, the pressure in the first volume 41 may still be sufficiently high (e.g. 20 bar) to move the piston 93 back even after pressure compensation with the second volume 42 and thus to move the closure element 9 into the closed position.
Subsequently, the procedure can be started again by opening the compressed air valve 49.

When using the pneumatic actuator 4b as described above, moving the closure element in the opening direction is done by moving the pneumatic actuator in the second direction. Moving the closure element in the closing direction is done by moving the pneumatic actuator in the first direction.

FIG. 2 shows an embodiment with an alternative pneumatic actuator 4b to the one shown in FIG. 1. The entire pneumatic actuator shown in FIG. 2 can be used, or only individual elements, e.g.
a piston throttle 100 and/or
a closure element 9 with hollow cylinder instead of the piston rod as piston connecting element 94 and/or
a cylinder discharge valve 46 with a section 101 of the compressed air filling line
   be combined with a pressure wave generator 1 as shown in FIG. 1. Furthermore, the embodiment may also comprise a heating element 99 (not shown).

The operation is basically the same as that of the embodiment of FIG. 1, with the following differences in the realization of individual elements:

The piston connecting element 94, which connects the piston 93 to the closure element 9, is formed by a hollow cylinder. The piston 93 encloses a rear closure guide 98, which can be designed as a general cylinder, in particular as a circular cylinder, and can be moved linearly along the same in the direction of movement. The piston connecting element 94 surrounds the bearing element 14, which is fixedly connected to a housing 16. The second volume 42 is located between the rear closure guide, the piston 93 and the inside of the hollow cylinder or piston connecting element 94.

The throttle between the first volume 41 and the second volume 42 is implemented as a piston throttle 100 through one or more holes through the piston 93. In addition or alternatively, however, the function of the piston throttle can also be performed by a gap between the piston 93 and the rear closure guide 98.

The section 101 of the compressed air filling line 48, through which the first volume 41 is supplied with the control medium, does not run through the housing 16 but through the plug of the cylinder discharge valve 46, for example as a bore, and can also be called the piston throttle of the cylinder discharge valve 46. Thus, the first volume 41 is supplied with the control medium via the discharge valve volume 51.

End position damping can be dispensed with. If end position damping is to be implemented in the embodiment of FIG. 5, this can be done as in FIG. 1 by means of a projecting piston closure element 95 which moves into the cylinder inlet/outlet 45, or by the cylinder inlet/outlet 45 being guided laterally into the first volume 41 and closed by the piston 93 moving over the cylinder inlet/outlet 45 during the opening movement.

In embodiments (not shown), two or three or more closure elements 9 are arranged parallel to each other to increase a total outlet area. They can be triggered synchronously with each other or simultaneously, respectively, to generate a pressure wave of higher energy than with a single closure element 9. In this case, multiple closure elements are connected to a single pressure chamber 2 and are actuated by a single pneumatic actuator. Such a parallel arrangement of closure elements 9 can also be realized with pressure wave generators, which use explosions to generate the pressure in the pressure chamber and/or to drive the closure element.

A controller 20 is configured to carry out the method steps described. For this purpose, the controller 20 is configured to control the compressed air valve 49, the working medium valve 10 and the cylinder discharge valve 46. The cylinder discharge valve 46 can be controlled by means of the discharge pilot valve 47.

FIGS. 3 and 4 show embodiments with a heater 80 for heating the working medium. According to the embodiment of FIG. 3, the heater 80 is arranged to heat the working medium as it flows through the first filling line or working medium filling line 12. The heated air does not experience any pressure increase. According to the embodiment of FIG. 4, the heater 80 is arranged to heat the working medium as it flows through a circulation line 84. The circulation line 84 leads from the pressure chamber 2 through the heater 80 and back to the pressure chamber 2. The heating increases both temperature and pressure in the pressure chamber 2. A circulation blower 85 may be arranged to convey the working medium through the circulation line 84.

The heater can each have a heat exchanger 81 with heat exchanger elements 82 around which the working medium flows. The heat exchanger elements 82 can be heated by an electric heater 83.

In another embodiment, not shown, heat exchanger elements 82 are arranged in the pressure chamber 2.

1. A method of operating a pressure wave generator (1) with a pressure chamber (2), wherein the pressure wave generator (1) comprises
a closure element (9) which, in a closed position, closes the pressure chamber (2) with respect to an outlet (15) and, in an open position, allows a working medium to flow out of the pressure chamber (2) into the outlet (15);
an actuator by means of which the closure element (9) can be brought from the closed position into the open position and, in particular, can also be brought from the open position into the closed position;
wherein the method comprises repeatedly performing the following steps:
filling the pressure chamber (2) with a gaseous working medium at a pressure of over one hundred bar;
moving the actuator and thereby moving the closure element (9) in an opening direction to open the pressure chamber (2) with respect to the outlet (15), and discharging the pressurized working medium from the pressure chamber (2) through the outlet (15) within a discharge time period of less than fifteen milliseconds.

2. The method according to claim 1, wherein a volume of the pressure chamber (2) is more than three liters, in particular more than four liters, in particular more than five liters.

3. The method according to any of the preceding claims, wherein an area at a narrowest point of the outlet (15) is more than twenty square centimeters, in particular more than eighty square centimeters, in particular more than one hundred eighty square centimeters.

4. The method according to any of the preceding claims, wherein an opening speed of the closure element (9) is more than ten meters/second, in particular more than twenty meters/second, in particular at least thirty meters/second.

5. The method according to any of the preceding claims, wherein a stroke of the closure element (9) during the opening and closing movement is between thirty and one hundred and fifty millimeters, in particular between forty and one hundred millimeters, in particular between fifty and eighty millimeters.

6. The method according to any of the preceding claims, wherein the filling of the pressure chamber (2) with the working medium takes place at a pressure of more than one hundred and fifty bar, in particular of more than two hundred bar.

7. The method according to any of the preceding claims, wherein the discharge time period is less than ten milliseconds, in particular less than five milliseconds, in particular less than three milliseconds.

8. The method according to any of the preceding claims, wherein the working medium is one of air, nitrogen or steam, in particular superheated steam or saturated steam.

9. The method according to any of the preceding claims, comprising the step carried out during filling, or after filling and before opening the pressure chamber:
heating the working medium supplied to the pressure chamber or located in the pressure chamber, in particular to 200 degrees Celsius to 450 degrees Celsius, in particular to 250 degrees Celsius;
in particular wherein the heating is carried out with electrical energy.

10. The method according to any of the preceding claims, using a pneumatic actuator (4b) which comprises
a first piston surface (91) which acts against a gaseous control medium in a first volume (41), wherein a pressure in the first volume (41) causes an actuator force on the first piston surface (91) in a first direction;
a second piston surface (92) which acts against the control medium in a second volume (42), wherein a pressure in the second volume (42) on the second piston surface (92) causes an actuator force in a second direction opposite to the first direction;
wherein the closure element (9) can be brought from the closed position into the open position by the pneumatic actuator (4b) and in particular can also be brought from the open position into the closed position;
wherein the method of opening the pressure chamber (2) comprises the following steps:
discharging at least part of the control medium from the first volume (41), in particular by opening an inlet/outlet opening of the first volume (41), and thereby opening the pressure chamber (2);
by a faster pressure drop in the first volume (41) than in the second volume (42), moving the actuator in the second direction and thereby moving the closure element (9) in an opening direction to open the pressure chamber (2) with respect to the outlet (15), and discharging the working medium from the pressure chamber (2) through the outlet (15).

11. The method according to any of claims 1 to 9, using a pneumatic actuator (4b) which comprises
a first piston surface (91) which acts against a gaseous control medium in a first volume (41), wherein a pressure in the first volume (41) causes an actuator force on the first piston surface (91) in a first direction;
a second piston surface (92) which acts against the control medium in a second volume (42), wherein a pressure in the second volume (42) on the second piston surface (92) causes an actuator force in a second direction opposite to the first direction;
wherein the closure element (9) can be brought from the closed position into the open position by the pneumatic actuator (4b) and in particular can also be brought from the open position into the closed position;
wherein the method comprises repeatedly performing the following steps:
filling the first volume (41) with a pressurized gaseous control medium, in particular by means of a filling valve, for example a compressed air valve (49);
pressure compensation between the first volume (41) and the second volume (42) by a throttle and thereby, due to a surface difference of the first piston surface (91) and the second piston surface (92), moving the actuator in the first direction and thereby moving a closing element (9) in a closing direction and closing the pressure chamber (2);
filling the pressure chamber (2) with a gaseous working medium;
discharging at least part of the control medium from the first volume (41), in particular by opening an inlet/outlet opening of the first volume (41), and thereby opening the pressure chamber (2);
by a faster pressure drop in the first volume (41) than in the second volume (42), moving the actuator in the second direction and thereby moving the closure element (9) in an opening direction to open the pressure chamber (2) with respect to the outlet (15), and discharging the working medium from the pressure chamber (2) through the outlet (15).

12. A pressure wave generator (1) for carrying out the method according to one of the preceding claims, comprising a pressure chamber (2), as well as
a closure element (9) which, in a closed position, closes the pressure chamber (2) with respect to the outlet (15) and, in an open position, —allows a working medium to flow out of the pressure chamber (2) into the outlet (15);
an actuator by which the closure element (9) can be brought from the closed position into the open position and from the open position into the closed position;
wherein a volume of the pressure chamber (2) is more than three liters, in particular more than four liters, in particular more than five liters;
wherein an area at the narrowest point of the outlet (15) is more than twenty square centimeters, in particular more than eighty square centimeters, in particular more than one hundred eighty square centimeters;
wherein a stroke of the closure element (9) during the opening and closing movement is between thirty and one hundred and fifty millimeters, in particular between forty and one hundred millimeters, in particular between fifty and eighty millimeters.

13. The pressure wave generator (1) according to claim 12, wherein a closure area of a closure opening, which is respectively closed and opened by the closure element (9), is at least as large as the area at the narrowest point of the outlet, in particular at least ten percent larger than the area at the narrowest point of the outlet.

14. The pressure wave generator (1) according to claim 12 or 13, wherein the closure element (9) is hollow cylindrical and is arranged to close or open a closure opening corresponding to a cylindrical surface.

15. The pressure wave generator (1) according to one of claims 12 to 14, wherein, during the opening movement of the closure element (9) starting from an end position in which the closure element (9) closes the closure opening, the closure element opens the closure opening only after covering a minimum distance which is different from zero, in particular wherein said distance is more than five millimeters or more than eight millimeters.

16. A pressure wave generator (1) for carrying out the method according to claim 9, comprising a pressure chamber (2), and
a closure element (9) which, in a closed position, closes the pressure chamber (2) with respect to an outlet (15) and, in an open position, allows a working medium to flow out of the pressure chamber (2) into the outlet (15);
an actuator by which the closure element (9) can be brought from the closed position into the open position and from the open position into the closed position;
a heater (80), which is arranged to heat a working medium supplied to the pressure chamber (2) or a working medium present in the pressure chamber (2), in particular wherein the heater (80) is an electric heater.

17. The pressure wave generator (1) according to one of claims 12 to 16, comprising a controller (20) which is configured to control the pressure wave generator (1) for carrying out the method according to at least one of the method claims 1 to 11.
